(19) United States
(12) Patent Application Publication
(10) Pub. No.: US 2026/0171711 A1
(43) Pub. Date: Jun. 18, 2026

(54) Electrical Connector Interface Having Protrusions For Sealing Against A Gasket

(71) Applicant: TE Connectivity Solutions GmbH, Schaffhausen (CH)

(72) Inventor: Jack BROWN, Hastings (GB)

(73) Assignee: TE Connectivity Solutions GmbH, Schaffhausen (CH)

(21) Appl. No.: 18/985,199

(22) Filed: Dec. 18, 2024

(51) Int. Cl. H01R 13/52

(52) U.S. Cl. CPC H01R 13/5219

(57) ABSTRACT

An electrical connector with a dielectric housing which has a mating surface and an assembly surface. A plurality of terminal receiving passageways extends between the mating surface and the assembly surface. A plurality of terminals are positioned in the plurality of terminal receiving passageways. A plurality of protrusions extends from the mating surface in a direction away from the assembly surface. The protrusions surround openings of the terminal receiving passageways. As the connector mated with a mating connector, the plurality of protrusions are configured to engage and compress a flat elastomer gasket of the mating connector to provide a seal around each of the terminal receiving passageways and the terminals.

### FIELD OF THE INVENTION

The invention relates to a sealed electrical connector assembly. In particular, an electrical connector with protrusions on an interface for cooperating with a gasket of a mating connector to provide an interfacial seal.

### BACKGROUND OF THE INVENTION

It is known to provide electrical connector assemblies with sealing members to protect the contacts and the mating interface. These connector assembles often use an interface seal for sealing a joint between the coupled connector members. The sealing member is disposed in a recess of one connector member and may have arcuate ribs to contact the other connector member.

A disadvantage of the above sealing members is that the ribs are either deformed or bent over axially when the connector members are coupled together and may not provide an adequate seal. Another disadvantage of the sealing members is that an increased force is required to deform or bend the ribs upon insertion of one connector member into the other connector member. Yet another disadvantage of the sealing members is that they tend to roll or twist when the connector members are coupled together and may not provide an adequate seal between the connector members.

It would therefore be beneficial to provide an electrical connector assembly which provides proper sealing, but overcomes the disadvantages of the known art. In particular, it would be beneficial to provide an electrical connector with protrusions molded on an interface for cooperating with a gasket of a mating connector to provide an interfacial seal.

### SUMMARY OF THE INVENTION

The following provides a summary of certain illustrative embodiments of the present invention. This summary is not an extensive overview and is not intended to identify key or critical aspects or elements of the present invention or to delineate its scope.

An object is to provide a seal which does not rely on the elastomeric seal having protrusions provided thereon which must be compressed into a recess of a mating connector.

An object is to provide projections on an interface of a first connector which cooperates with a gasket on a mating interface of a second connector to compress the gasket to provide the environmental seal required between the first connector and the second connector.

An embodiment is directed to an electrical connector with a dielectric housing which has a mating surface and an assembly surface. A plurality of terminal receiving passageways extends between the mating surface and the assembly surface. A plurality of terminals are positioned in the plurality of terminal receiving passageways. A plurality of protrusions extends from the mating surface in a direction away from the assembly surface. The protrusions surround openings of the terminal receiving passageways. As the connector mated with a mating connector, the plurality of protrusions are configured to engage and compress a flat elastomer gasket of the mating connector to provide a seal around each of the terminal receiving passageways and the terminals.

An embodiment is directed to an electrical connector assembly which has a first electrical connector and a second electrical connector. The first electrical connector has a first dielectric housing with a first mating surface and a first assembly surface. A plurality of first terminal receiving passageways extends between the first mating surface and the first assembly surface. A plurality of first terminals are positioned in the plurality of first terminal receiving passageways. A plurality of protrusions extends from the first mating surface in a direction away from the first assembly surface. The protrusions surround openings of the first terminal receiving passageways. The second electrical connector has a second dielectric housing with a second mating surface and a second assembly surface. A plurality of second terminal receiving passageways extends between the second mating surface and the second assembly surface. A plurality of second terminals are positioned in the plurality of second terminal receiving passageways. A gasket is provided in engagement with the second mating surface. As the first connector is mated with the second connector, the plurality of protrusions are configured to engage and compress the gasket circumferentially around the first terminal receiving passageways to provide a seal around each of the first terminal receiving passageways and the first terminals.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

FIG. 1 is a front perspective view of a first electrical connector and a mating second electrical connector shown prior to mating.

FIG. 2 is a back perspective view of the first electrical connector and the mating second electrical connector of FIG. 1.

FIG. 3 is an enlarged perspective view of a mating interface of the first connector of FIG. 1.

FIG. 4 is an enlarged side view of the first connector of FIG. 1 with a partial cross-sectional view of a first respective terminal receiving passage.

FIG. 5 is an enlarged side view of the first connector of FIG. 1 with a partial cross-sectional view of a second respective terminal receiving passage.

FIG. 6 is a perspective view of the first connector and the mating second connector of FIG. 1 shown in the mated position.

FIG. 7 is a cross-sectional view of the mated first connector and the mating second connector taken along line 7-7 of FIG. 6.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

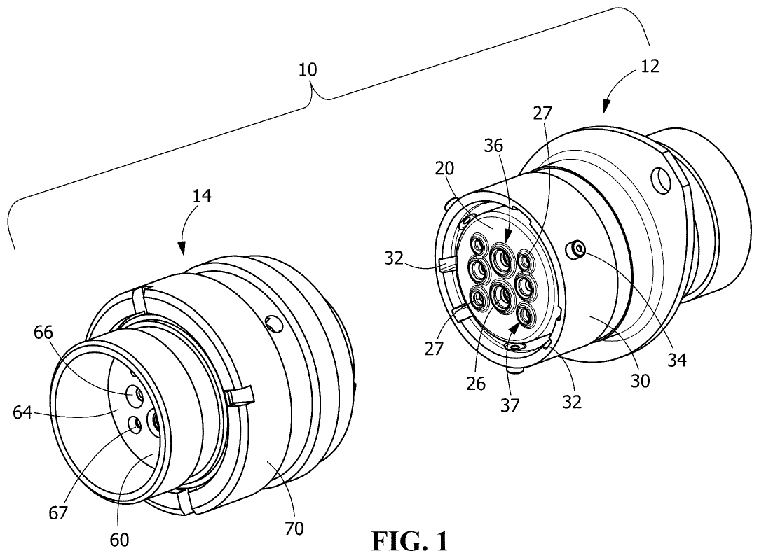

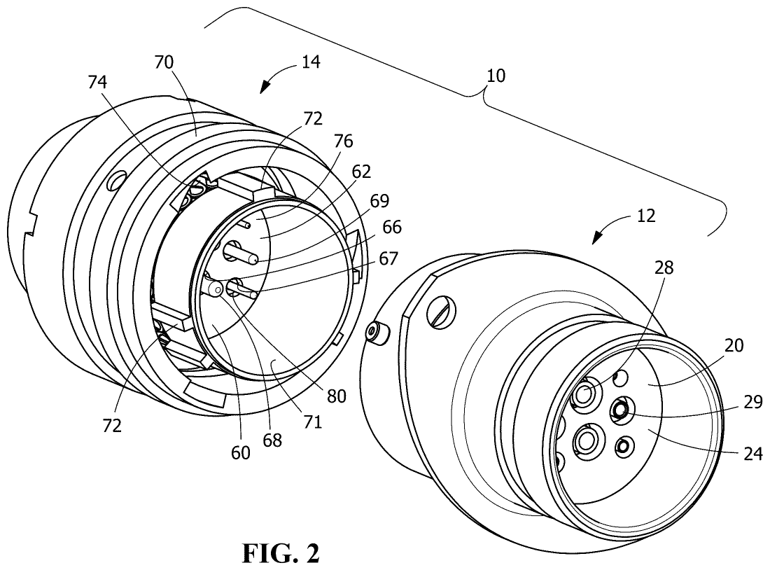

As shown in FIGS. 1 and 2, an electrical connector assembly 10 includes a first electrical connector 12 and a mating second electrical connector 14. In the illustrative embodiment shown, the first connector 12 and the second connector 14 are circular connectors, but other configurations of connectors can be used.

The first connector 12 includes a dielectric housing or insert 20, having a mating surface 22, an assembly surface 24, and a plurality of terminal receiving passageways 26, 27 extending therebetween. The terminal receiving passageways 26 have a larger diameter than the terminal receiving passageways 27. Connector 12 includes a plurality of signal terminals 28 disposed in respective terminal receiving passageway 26 and ground terminals 29 disposed in respective terminal receiving passageway 27. The terminals 28, 29 are terminated to respective conductors (not shown). In the illustrative embodiment shown, the terminals 28, 29 are socket terminals, but other types of terminals may be used. Connector 12 includes a conductive shell 30 disposed around dielectric housing 20. The conductive shell 30 includes one or more polarizing recesses 32 positioned periodically on an inside surface thereof. Mounting projections 34 extend from an outer surface of the conductive shell 30.

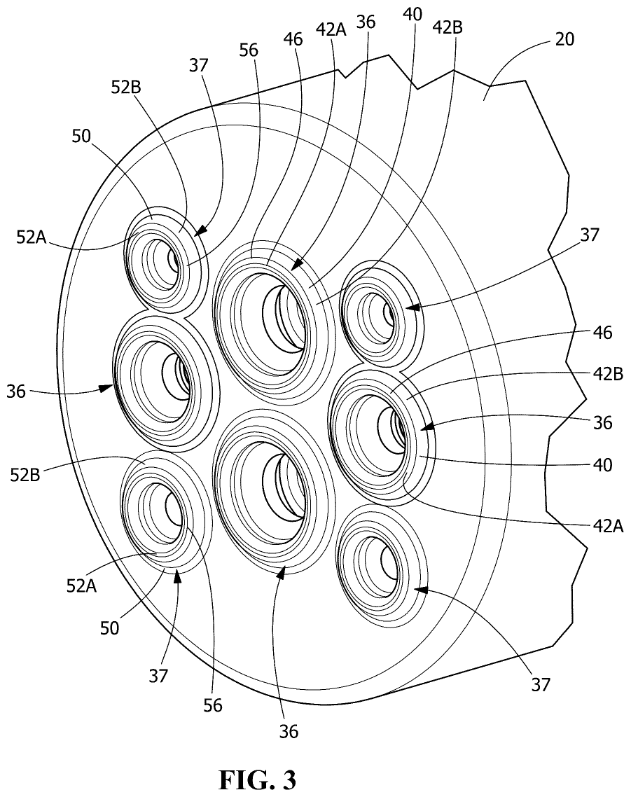

Referring to FIGS. 3 through 5, the mating surface 22 of the housing 20 of the first connector 12 has first protrusions 36 and second protrusions 37 which extend from the mating surface 22 in a direction away from the assembly surface 24. The first protrusions 36 have a tubular configuration and surround the opening of the terminal receiving passageways 26. The second protrusions 37 have a tubular configuration and surround the opening of the terminal receiving passageways 27. While the tubular first protrusions 36 have a larger diameter than the tubular second protrusions 37, the remaining configuration of the protrusions 36, 37 is essentially the same. In the illustrative embodiment shown, the first protrusions 36 and the second protrusions 37 are integrally molded with the housing 20. Although cylindrical terminal receiving passageways 26, 27 and tubular protrusions 36, 37 are shown, the terminal receiving passageways and protrusions may have other configurations and the protrusions 36, 37 may be separately formed pieces which are attached to the housing 20.

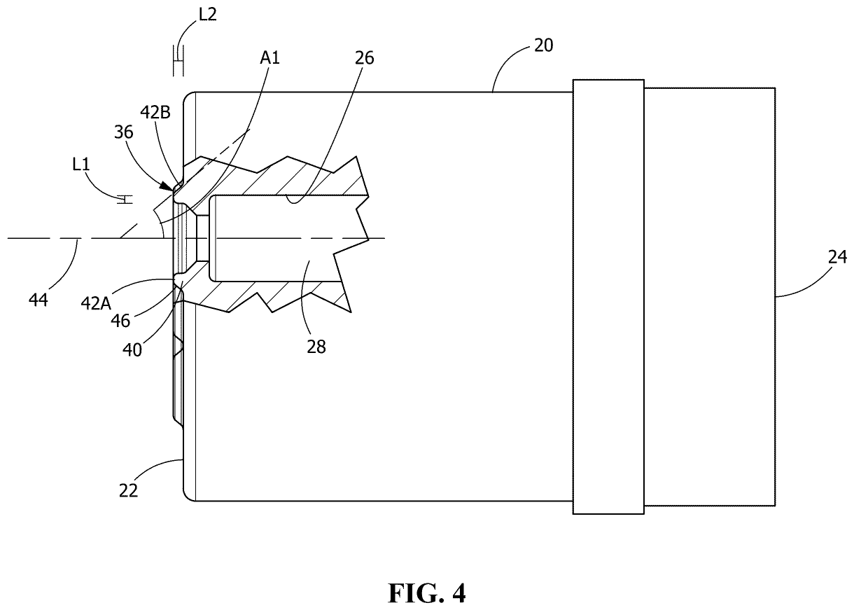

As shown in FIG. 4, the walls 40 of the protrusions 36 are made of various different fillets 42. Top fillets 42A are flat with each having a length L1 of, but not limited to, greater than approximately 0.11 mm, or between approximately 0.11 mm to approximately 0.30 mm. The top fillets 42A are spaced a distance L2 of approximately 0.40 mm or greater from the mating surface 22 of the housing 20. The side fillets 42B extend at an angle A1 of between approximately 40 degrees and approximately 80 degrees when measured from the longitudinal axis 44 of the terminal receiving passageways 26. The transition portion 46 between each top fillet 42A and each side fillet 42B has a radiused configuration to eliminate any sharp edges. Each of the transition portions 46 has a radius of 0.20 mm or greater. In other embodiments, the protrusions 36 may have additional fillets provided on the walls 40.

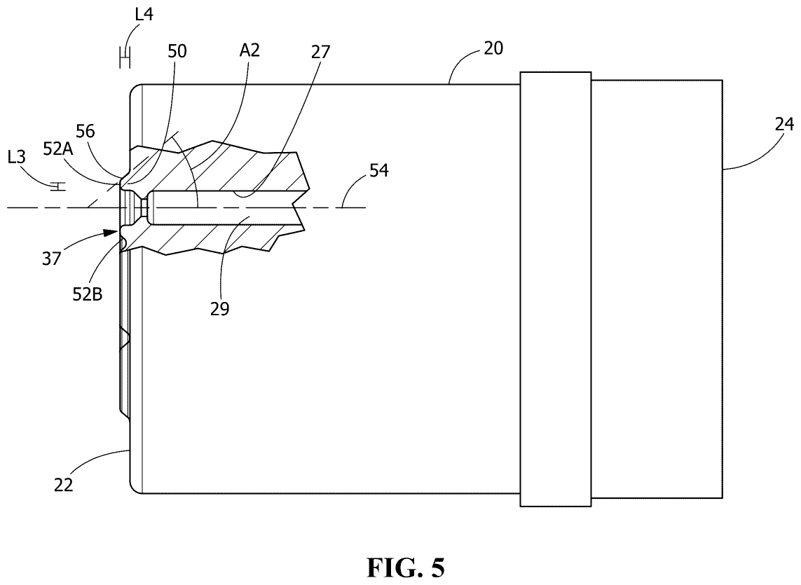

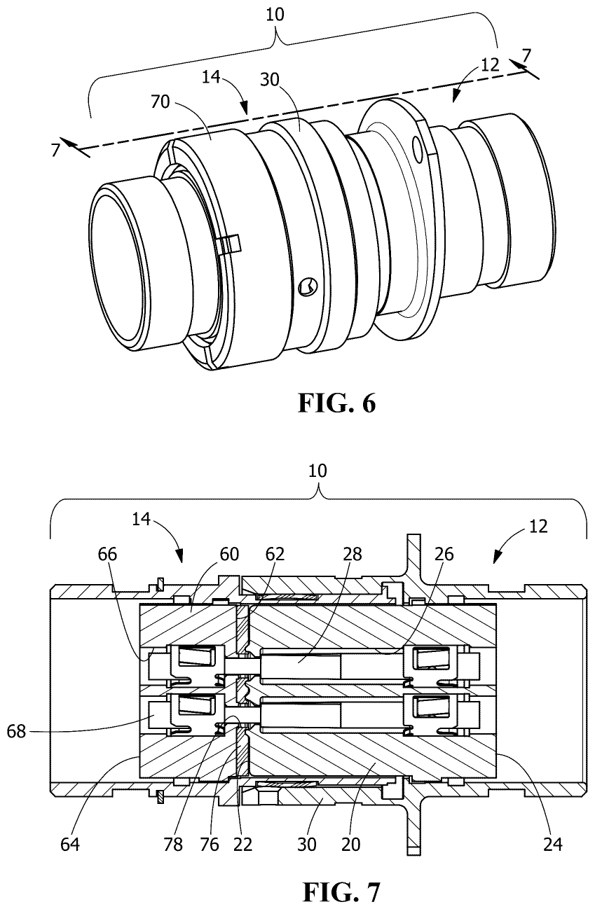

As shown in FIG. 5, the walls 50 of the protrusions 37 are made of various different fillets 52. Top fillets 52A are flat with each having a length L3 of, but not limited to, greater than approximately 0.11 mm, or between approximately 0.11 mm to approximately 0.30 mm. The top fillets 52A are spaced a distance L4 of approximately 0.40 mm or greater from the mating surface 22 of the housing 20. The side fillets 52B extend at an angle A2 of between approximately 40 degrees and approximately 80 degrees when measured from the longitudinal axis 54 of the terminal receiving passageways 27. The transition portion 56 between each top fillet 52A and each side fillet 52B has a radiused configuration to eliminate any sharp edges. Each of the transition portions 56 has a radius of 0.20 mm or greater. In other embodiments, the protrusions 37 may have additional fillets provided on the walls 40. In various illustrative embodiments, the protrusions 37 may have the same dimensions and/or configuration as protrusions 36, and in other illustrative embodiments, the protrusions 37 and the protrusions 36 may have different dimensions and/or configuration.

As shown in FIGS. 1 and 2, connector 14 includes a dielectric housing 60, having a mating surface 62, an assembly surface 64, and a plurality of terminal receiving passageways 66, 67 extending therebetween. The terminal receiving passageways 66 have a larger diameter than the terminal receiving passageways 6. Connector 14 includes a plurality of signal terminals 68 disposed in respective terminal receiving passageway 66 and ground terminals 69 disposed in respective terminal receiving passageway 67. The terminals 68, 69 are terminated to respective conductors (not shown). In the illustrative embodiment shown, the terminals 68, 69 are pin terminals, but other types of terminals may be used. Connector 14 includes a shroud 71 disposed around dielectric housing 60. The conductive shroud 71 surrounds ends of the terminals 68, 69.

The shroud 71 includes one or more polarizing projections 72 positioned periodically on an outside surface thereof. The polarizing projections 72 cooperate with the polarizing recesses 32 to properly align connector 12 to connector 14 as they are mated together. Connector 14 further includes one or more mounting recesses 74 which extend from an inside surface of the shroud 71. The mounting recesses cooperate with the mounting recesses 34 to secure the first connector and the second connector together in the mated position.

A gasket 76 is provided in engagement with the mating surface 62. The gasket 76 is retained in a recess 78 of the shroud 71. The gasket 76 has openings 80 for receiving the terminals 68, 69 therethrough. In the illustrative embodiment shown, the gasket 76 is a flat elastomer gasket, but other materials may be used for the gasket.

As the first connector 12 and the second connector 14 are mated to form the connector assembly 10, the terminals 28, 29 of the first connector 12 are mated with the terminals 68, 69 of the second connector 14. As this occurs, the gasket 76 provided on the mating surface 62 of the housing 60 of the second connector 14 is moved into engagement with the tubular first protrusions 36 and the tubular second protrusions 37.

As the second connector 14 is moved to the fully mated position with the first connector 12, the first protrusions 36 and the second protrusions 37 engage and compress the flat elastomer gasket 76. The compression of the flat elastomer gasket 76 circumferentially around the opening to the terminal receiving passageways 26, 27 creates a seal around each of the terminal receiving passageways 26, 27 and the terminals 28, 29 positioned therein, thereby isolating the terminals 28, 29 and providing environmental protection.

The tubular protrusions 36, 37 which extend from the mating surface 22 of the housing 20 of the first connector 12 are configured for the purpose of sealing against the flat elastomer gasket 76 provided on the mating surface 62 of the housing 60 of the second connector 14. The protrusions 36, 37 cause compression of the flat elastomer gasket 76 which provides the environmental sealing required. This invention differs from the known connector interfaces, in which the protrusions or ribs are an integral component of the elastomer interfacial seal and must compress into corresponding recesses on the socket interface, resulting in the issues previously described.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. An electrical connector comprising:
a dielectric housing having a mating surface and an assembly surface;
a plurality of terminal receiving passageways extending between the mating surface and the assembly surface;
a plurality of terminals positioned in the plurality of terminal receiving passageways;
a plurality of protrusions extending from the mating surface in a direction away from the assembly surface, the protrusions surrounding openings of the terminal receiving passageways;
wherein as the connector mated with a mating connector, the plurality of protrusions are configured to engage and compress a flat elastomer gasket of the mating connector to provide a seal around each of the terminal receiving passageways and the terminals.

2. The electrical connector as recited in claim 1, wherein the plurality of protrusions have tubular configurations.

3. The electrical connector as recited in claim 1, wherein the plurality of protrusions are integrally molded with the housing.

4. The electrical connector as recited in claim 1, wherein the plurality of protrusions have walls comprising different fillets.

5. The electrical connector as recited in claim 4, wherein top fillets of the different fillets have lengths of greater than approximately 0.11 mm.

6. The electrical connector as recited in claim 4, wherein top fillets of the different fillets have lengths of between approximately 0.11 mm to approximately 0.30 mm.

7. The electrical connector as recited in claim 4, wherein the top fillets are spaced approximately 0.40 mm or greater from the mating surface of the housing.

8. The electrical connector as recited in claim 4, wherein side fillets of the different fillets extend at angles of between approximately 40 degrees and approximately 80 degrees as measured from longitudinal axes of respective terminal receiving passageways.

9. The electrical connector as recited in claim 4, wherein transition portions are provided between top fillets and side fillets, the transition portions have a radiused configuration with radiuses of 0.20 mm or greater.

10. The electrical connector as recited in claim 1, wherein the connector has a conductive shell disposed around dielectric housing.

11. The electrical connector as recited in claim 1, wherein the plurality of protrusions and have one or more first protrusions and one or more second protrusions, the one or more first protrusions have larger diameters than the one or more second protrusions.

12. The electrical connector as recited in claim 1, wherein the plurality of terminal receiving passageways have one or more first terminal receiving passageways and one or more second terminal receiving passageways, the first terminal receiving passageways having larger diameters than the second terminal receiving passageways.

13. An electrical connector assembly comprising:
a first electrical connector comprising:
a first dielectric housing having a first mating surface and a first assembly surface;
a plurality of first terminal receiving passageways extending between the first mating surface and the first assembly surface;
a plurality of first terminals positioned in the plurality of first terminal receiving passageways;
a plurality of protrusions extending from the first mating surface in a direction away from the first assembly surface, the protrusions surrounding openings of the first terminal receiving passageways;
a second electrical connector comprising:
a second dielectric housing having a second mating surface and a second assembly surface;
a plurality of second terminal receiving passageways extending between the second mating surface and the second assembly surface;
a plurality of second terminals positioned in the plurality of second terminal receiving passageways;
a gasket provided in engagement with the second mating surface;
wherein as the first connector is mated with the second connector, the plurality of protrusions are configured to engage and compress the gasket circumferentially around the first terminal receiving passageways to provide a seal around each of the first terminal receiving passageways and the first terminals.

14. The electrical connector assembly as recited in claim 13, wherein the plurality of protrusions are integrally molded with the housing.

15. The electrical connector assembly as recited in claim 13, wherein the plurality of protrusions have walls comprising different fillets.

16. The electrical connector assembly as recited in claim 15, wherein top fillets of the different fillets have lengths of greater than approximately 0.11 mm.

17. The electrical connector assembly as recited in claim 15, wherein top fillets of the different fillets have lengths of between approximately 0.11 mm to approximately 0.30 mm.

18. The electrical connector assembly as recited in claim 16, wherein the top fillets are spaced approximately 0.40 mm or greater from the mating surface of the housing.

19. The electrical connector assembly as recited in claim 18, wherein side fillets of the different fillets extend at angles of between approximately 40 degrees and approximately 80 degrees as measured from longitudinal axes of respective terminal receiving passageways.

20. The electrical connector assembly as recited in claim 19, wherein transition portions are provided between the top fillets and the side fillets, the transition portions have a radiused configuration with radiuses of 0.20 mm or greater.
